(19) United States
(12) Patent Application Publication
(10) Pub. No.: US 2002/0023307 A1
(43) Pub. Date: Feb. 28, 2002

(54) Dust remover

(75) Inventors: Noriyuki Haba, Osaka (JP); Hideo Komano, Tokyo (JP)

Correspondence Address: SUGHRUE, MION, ZINN, MACPEAK & SEAS, PLLC., 2100 Pennsylvania Avenue, N.W., Washington, DC, 20037, US

(73) Assignee: NITTO DENKO CORPORATION and RAYON INDUSTRIAL CO., LTD

(21) Appl. No.: 09/902,638

(22) Filed: Jul. 12, 2001

(30) Foreign Application Priority Data
Jul. 12, 2000 (JP) 2000-211881

(51) Int. Cl. B08B 1/02; B08B 11/00

(52) U.S. Cl. 15/3; 15/102; 15/256.52

(57) ABSTRACT

The present invention provides a dust remover having a dust removal roller for removing the dust attached on the surface of a dust removal object by coming in contact with the surface of the dust removal object while rotating, and an adhesive tape roller for transferring the dust adherent to an outer peripheral face of the dust removal roller to an adhesive layer of the adhesive tape roller to clean the dust removal roller, while rotating with its outer peripheral face in contact with the outer peripheral face of the dust removal roller. An outer peripheral layer of the dust removal roller is made of a non-silicone elastic body, and a difference Δδ between a solubility parameter (SP value) δ_{A} of the non-silicone elastic body and a solubility parameter (SP value) δ_{B} of an adhesive applied on the adhesive layer of the adhesive tape roller is 1.0 [J/cm³]^{½} or greater.

### BACKGROUND OF THE INVENTION

1. Field of the Invention

The present invention relates to a dust remover for removing the dust adhering to a variety of electronic materials such as a printed circuit board and a liquid crystal board.

The present application is based on Japanese Patent Application No. 2000-211881, which is incorporated herein by reference.

2. Description of the Related Art

In a manufacturing process of the electronic materials including the printed circuit board and the liquid crystal board, a dry type dust remover with a dust removal roller is employed to remove the dust adhering to the materials. This dry type dust remover comprises the dust removal roller and an adhesive tape roller which rotate with their peripheral faces in contact with each other, and can collect the dust of a dust removal object in such a way as to place the dust removal object into contact with the dust removal roller while rotating, and transfer the dust adherent to the dust removal roller onto the adhesive tape roller, whereby the dust removal roller can be always kept in a clean state.

Conventionally, silicone rubber was used as an outer peripheral layer of the dust removal roller in the dry type dust remover, because it is superior in the peeling property, less sticky with the adhesive tape roller, and able to easily transfer the dust adherent to the dust removal roller onto the adhesive tape roller (see Unexamined Japanese Patent publication No. Hei. 8-215132). However, there is the problem that the transition of silicone from the silicone rubber has adverse effect on the printed circuit board along with the higher density and fineness of the printed circuit board.

On one hand, when non-silicone rubber is employed as the outer peripheral layer of the dust removal roller, there is a problem that the contact between the dust removal roller and the adhesive tape roller is so strong that the rotation of the dust removal roller is impeded, or the adhesive composing the adhesive layer of the adhesive tape roller is taken out to the dust removal roller.

### SUMMARY OF THE INVENTION

Accordingly, it is an object of the present invention to provide a dust remover which can remove the dust adherent to a dust removal roller by transferring smoothly the dust to an adhesive tape roller, while preventing adverse effect on a dust removal object such as electronic materials due to transition of silicone, without the adhesive tape roller being too intimately contacted with the dust removal roller.

As a result of the careful examination to accomplish the above object, the present inventors found that if an outer peripheral layer of the dust removal roller consists of a non-silicone elastic body, with a difference between a solubility parameter of the non-silicone elastic body and a solubility parameter of an adhesive composing an adhesive layer of the adhesive tape roller being set to be a predetermined value or greater, the dust can be removed smoothly and efficiently from the dust removal object without transition of silicone to the dust removal object, and thus completed the present invention.

The present invention provides a dust remover comprising a dust removal roller for removing the dust attached on the surface of a dust removal object by coming in contact with the surface of the dust removal object while rotating, and an adhesive tape roller for transferring the dust adherent to an outer peripheral face of the dust removal roller to an adhesive layer of the adhesive tape roller to clean the dust removal roller, while rotating with its outer peripheral face in contact with the outer peripheral face of the dust removal roller, characterized in that an outer peripheral layer of the dust removal roller consists of a non-silicone elastic body, and a difference Δδ between a solubility parameter (SP value) δ_{A} of the non-silicone elastic body and a solubility parameter (SP value) δ_{B} of an adhesive applied on the adhesive layer of the adhesive tape roller is 1.0 [J/cm³]^{½} or greater.

Features and advantages of the invention will be evident from the following detailed description of the preferred embodiments described in conjunction with the attached drawings.

### BRIEF DESCRIPTION OF THE DRAWINGS

In the accompanying drawings:

FIG. 1 is an explanatory view illustrating an example of the use condition of a dust remover according to the present invention; and

FIG. 2 is a cross-sectional view illustrating an example of an adhesive tape constituting an adhesive tape roller in the invention.

### DETAILED DESCRIPTION OF THE PREFERRED EMBODIMENTS

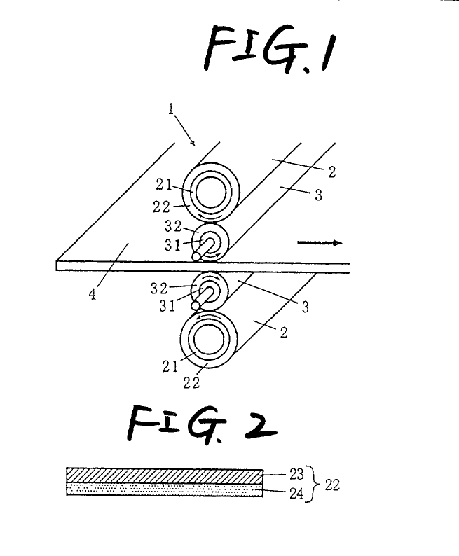

The embodiments of the present invention will be described below with reference to the drawings, as necessary. FIG. 1 is an explanatory view illustrating an example of a dust remover of the invention when in use. The arrow in the figure indicates the movement direction or rotational direction.

The dust remover 1 comprises a dust removal roller 3 for removing the dust attached on a surface of a dust removal object 4 by coming in contact with the surface while rotating, and an adhesive tape roller 2 for transferring the dust adherent to an outer peripheral face of the dust removal roller to an adhesive layer 22 of the adhesive-tape roller 2 while rotating with its outer peripheral face in contact with the outer peripheral face of the dust removal roller 3.

With this dust remover 1, the dust removal object 4 contaminated with the dust is placed between two dust removal rollers 3, 3, and passed therethrough to cause the dust on both faces of the dust removal object 4 to adhere to the surface of the dust removal rollers 3, so that the dust removal object 4 is cleaned. And the adhesive tape roller 2 having the adhesive layer 22 is rotated in contact with the outer peripheral face of the dust removal roller 3, so that the dust adherent to the dust removal roller 3 is transferred to the adhesive tape roller 2. Accordingly, the dust removal roller 3 is always kept in a clean state to come in contact with the dust removal object 4, so that the dust removal object can be cleaned efficiently. Incidentally, a pair of a combination of the adhesive tape roller 2 and the dust removal roller 3 are oppositely disposed with the dust removal object 4 like a sheet (plate) inserted between them in the illustrated dust remover 1. However, only one combination of the adhesive tape roller 2 and the dust removal roller 3 can be employed to clean one surface of the dust removal object 4.

The dust removal roller 3 comprises a core member (including a shank) 31, and an outer peripheral layer 32 composed of a non-silicone elastic body formed concentrically outside the core member 31. The sorts of the non-silicone elastic body are not specifically limited so far as it has elasticity, and include, for example, natural rubber, synthetic rubbers such as butyl rubber, acrylic rubber, and nitryl rubber, thermoplastic elastomer, and polyurethane. The thickness of the outer peripheral layer 32 composed of the non-silicone elastic body is not specifically limited, but may be normally about 1 mm to 20 mm.

In this invention, since the outer peripheral layer 32 of the dust removal roller 3 is composed of the non-silicone elastic body, there is no adverse effect on the dust removal object like electronic materials due to transition of silicone.

The adhesive tape roller 2 comprises a cylindrical core member 21 and an adhesive tape 22 wound around the cylindrical core member 21. FIG. 2 is a cross-sectional view illustrating an example of the adhesive tape 22. This adhesive tape 22 comprises a base material 23 and an adhesive layer 24 provided on one face of the base material 23, and is wound like a roll around the cylindrical core member 21 with the adhesive layer 24 faced outside.

The base material 23 is not specifically limited so far as it has self-supporting property, and may be a plastic film made of polypropylene, polyester, or vinyl chloride, paper, synthetic paper, or a laminate thereof, for example. The thickness of the base material 23 is not specifically limited, but may be normally from about 0.02 mm to 0.2 mm.

The sorts of adhesive constituting the adhesive layer 24 are not specifically limited, but may include acrylic adhesives, rubber-based adhesives, urethane-based adhesives, and olefin-based adhesives. Among others, the acrylic adhesives or rubber-based adhesives are often used. The thickness of the adhesive layer 24 may be appropriately selected in view of the dust removal performance from the dust removal roller 3, normally from 5 μm to 200 μm, and preferably from 10 μm to 50 μm.

A release agent layer made of long chain alkyl group containing polymer may be provided on the opposite face of the adhesive layer 24 in the base material 23, as required.

The dust remover of the invention has a combination of the dust removal roller 3 and the adhesive tape roller 2 such that a difference Δδ (absolute value) between a solubility parameter (SP value) δ_{A} of the non-silicone elastic body constituting the outer peripheral layer 32 of the dust removal roller 3 and a solubility parameter (SP value) δ_{B} of an adhesive composing the adhesive layer 24 of the adhesive tape roller 2 is 1.0 [J/cm³]^{½} or greater (e.g., from about 1.0 to 8.0 [J/cm³]^{½}), preferably 2.0 [J/cm³]^{½} or greater (e.g., from about 2.0 to 6.0 [J/cm³]^{½}).

When the difference Δδ is 1.0 [J/cm³]^{½} or greater, the adherence strength between the dust removal roller 3 and the adhesive tape roller 2 does not become too strong, even if employed in a state where the adhesive tape roller 2 is in close contact with the dust removal roller 3, whereby there is no problem that the rotation of the dust removal roller 3 is impeded, or the adhesive composing the adhesive layer 24 of the adhesive tape roller 2 is taken away by the dust removal roller 3. Therefore, while the dust adherent to the outer peripheral layer 32 of the dust removal roller 3 is being transferred onto the adhesive layer 24 of the adhesive tape roller 2 smoothly, the removal operation of the dust from the dust removal object 4 can be made efficiently. On the contrary, if the difference Δδ is below 1.0 [J/cm³]^{½}, the dust removal roller 3 and the adhesive tape roller 2 are strongly contacted, causing the aforementioned problem.

The solubility parameters (SP values) δ_{A} and δ_{B} can be obtained in the following manner. That is, the non-silicone elastic body or adhesive is soaked into a few (at least three) kinds of solvents having different solubility parameters (SP values) to measure the degree of swelling of the non-silicone elastic body or the adhesive, whereby the solubility parameter (SP value) of the solvent indicating the maximum degree of swelling is defined as the solubility parameter (SP value) (typical value) of the non-silicone elastic body or the adhesive. Note that the solubility parameter (SP value) of the solvent can be calculated in accordance with a Fedor method or a known set of data.

The degree of swelling of the non-silicone elastic body or the adhesive can be measured in the following manner.

(1) Weigh a Teflon membrane (about 10 cm square) and a kite string (about 12 cm) for use with the measurement (Ag).

(2) Wrap the non-silicone elastic body (or adhesive) of about 0.5 to 1 g employing the Teflon membrane and the kite string.

(3) Weigh a wrapped non-silicone elastic body prepared in (2), and subtract by the weight of the Teflon membrane and the kite string as measured in (1) to have a sample weight (Bg).

(4) Place the wrapped non-silicone elastic body into a glass bottle of 50 to 300 ml, add a solvent to be measured, put a lid, and soak at room temperatures for seven days.

(5) Take out the wrapped non-silicone elastic body, wipe out the solvent on the Teflon membrane quickly, and weigh (Cg)

(6) Dry the wrapped non-silicone elastic body in a dryer at 130° C. for two hours.

(7) Weigh the wrapped non-silicone elastic body after drying (Dg).

(8) Calculate the degree of swelling in accordance with the following expression.

Degree of swelling (%)={(C−A)/(D−A)}×100

In the above measuring method, when a solvent of high viscosity is employed, Nylon gauze may be used instead of Teflon membrane. Also, when a solvent of high boiling point is employed, the drying temperature is set near the boiling point of the solvent.

For the non-silicone elastic body or adhesive that is unbridged and fully eluted in the solvent such as polyisobutylene, the solubility parameter (SP value) of the non-silicone elastic body or adhesive can be obtained by shortening the solvent soaking time and making the same measurement as above. From the result of experiments, the elusion rate of the non-silicone elastic body or the adhesive is obtained, and the solubility parameter (SP value) of the solvent having the highest elusion rate can be defined as the solubility parameter (SP value) (typical value) of the non-silicone elastic body or adhesive.

For the solubility parameter (SP value) of the polymer for the non-silicone elastic body or adhesive, when the values obtained in the past experiments (or by the computation) are given in a book “Polymer Handbook” (Published by John Wiley $ Sons, Inc.), the values may be employed as the solubility parameter (SP value) δ_{A} or δ_{B} of the non-silicone elastic body or adhesive in this invention.

The dust remover of this invention is effective to remove the dust adherent to a variety of sorts of electronic materials such as the printed circuit board or liquid crystal plate. Note that after processing a certain amount of dust removal object, a portion of the adhesive tape 22 having the dust adhering thereto may be cut away by rewinding the adhesive tape 22, thereby exposing a new adhesive layer and performing the dust removal operation again in the same manner.

The present invention will be described below in detail by way of example, but the invention is not limited to those examples. The solubility parameter (SP value) of the elastic body constituting the outer peripheral layer of the dust removal roller and the solubility parameter (SP value) of the adhesive of the adhesive tape roller were obtained in the following manner. That is, the SP values for a few kinds of solvents were obtained in accordance with a Fedor expression, the degree of swelling for the sample was measured using those solvents, and the SP value of the solvent with the greatest degree of swelling was made the typical value of the SP value of the sample.

### EXAMPLE 1

(Dust removal roller)

A dust removal roller was fabricated by forming an elastic body containing butyl rubber as a main component with a solubility parameter (SP value) of 15.8 [J/cm³]^{½} around the outer periphery of a core member as large as 650 mm×40 mmφ concentrically in a thickness of 10 mm, with the surface being finished smoothly.

(Adhesive tape roller)

An adhesive tape was obtained by forming an adhesive layer on one face of a polypropylene film (base material) having a thickness of 60 μm by applying an acrylic adhesive with a solubility parameter of 19.0 [J/cm³]^{½} 20 μm thick thereon. An adhesive tape roller was fabricated by winding this adhesive tape around the cylindrical core member of 600 mm×75 mmφ, with the adhesive layer faced outside.

(Dust remover)

A dust remover of FIG. 1 was fabricated, using the dust removal roller and the adhesive tape roller. In this dust remover, a difference between a solubility parameter (SP value) of the elastic body constituting an outer peripheral layer of the dust removal roller and a solubility-parameter (SP value) of the adhesive of the adhesive tape roller was 3.2 [J/cm³]^{½}.

### EXAMPLE 2

(Dust removal roller)

A dust removal roller was fabricated by forming an elastic body containing acrylic rubber as a main component with a solubility parameter (SP value) of 18.6 [J/cm³]^{½} around the outer periphery of a core member as large as 650 mm×40 mmφ concentrically in a thickness of 10 mm, with the surface being finished smoothly.

(Adhesive tape roller)

An adhesive tape was obtained by forming an adhesive layer on one face of a polypropylene film (base material) having a thickness of 60 μm by applying a rubber based adhesive containing polyisobutylene rubber with a solubility parameter of 16.4 [J/cm³]^{½} 20 μm thick thereon. An adhesive tape roller was fabricated by winding this adhesive tape around the cylindrical core member of 600 mm×75 mmφ, with the adhesive layer faced outside.

(Dust remover)

A dust remover of FIG. 1 was fabricated, using the dust removal roller and the adhesive tape roller. In this dust remover, a difference between a solubility parameter (SP value) of the elastic body constituting an outer peripheral layer of the dust removal roller and a solubility-parameter (SP value) of the adhesive of the adhesive tape roller was 2.2 [J/cm³]^{½}.

### COMPARATIVE EXAMPLE 1

A dust remover of FIG. 1 was fabricated, using the dust removal roller as obtained in the example 1 and the adhesive tape roller as obtained in the example 2. In this dust remover, a difference between a solubility parameter (SP value) of the elastic body constituting the outer peripheral layer of the dust removal roller and a solubility parameter (SP value) of the adhesive of the adhesive tape roller was 0.6 [J/cm³]^{½}.

### COMPARATIVE EXAMPLE 2

A dust remover of FIG. 1 was fabricated, using the dust removal roller as obtained in the example 2 and the adhesive tape roller as obtained in the example 1. In this dust remover, a difference between a solubility parameter (SP value) of the elastic body constituting the outer peripheral layer of the dust removal roller and a solubility parameter (SP value) of the adhesive of the adhesive tape roller was 0.4 [J/cm³]^{½}.

### EVALUATION TEST 1

To compare the performances of the dust removers as obtained in the examples and the comparative examples, the continuous operation was conducted for 24 hours in a state where the dust removal roller and the adhesive tape roller were contacted and rotated. The rotation inhibition due to too intimate contact between the dust removal roller and the adhesive tape roller, and the take-out of the adhesive of the adhesive tape roller to the dust removal roller were evaluated in the following manner. The results are listed in a table 1.

(Rotation inhibition evaluation)

The number of rotations of the dust removal roller was measured at a fixed resistance value of the torque motor for the dust remover as obtained in the examples and the comparative examples.

(Take-out of adhesive)

Whether the take-out of the adhesive of the adhesive tape roller to the dust removal roller was present or not was visually measured, and evaluated with the following criteria.

◯ : No take-out of adhesive was seen.

x : Take-out of adhesive was seen.

TABLE 1

| | | | Comparative | Comparative |
|---|---|---|---|---|
| | Example 1 | Example 2 | Example 3 | Example 4 |
| Number of | 38 to 39 | 40 to 41 | 18 to 20 | 22 to 23 |
| of rotations | | | | |
| (rpm) | | | | |
| Take-out of | ◯ | ◯ | X | X |
| adhesive | | | | |

### EVALUATION TEST 2

A plastic sheet artificially contaminated with the dust was passed through the dust remover of the examples, whereby the dust removal performance was evaluated. As a result, the dust removal effect of the dust remover of the examples was confirmed to be excellent from the cleaned state of the plastic sheet and the dust removal roller, and the contaminated state with the dust transferred onto the adhesive tape roller.

With this invention, since the adhesive tape roller is not too closely contacted with the dust removal roller, there is no problem that the rotation of the dust removal roller is inhibited or the adhesive of the adhesive tape roller is taken out to the dust removal roller, whereby the dust of the dust removal object can be efficiently removed. Also, silicone from silicone rubber is not transferred to the dust removal object, whereby there is no adverse effect on the electronic materials such as printed circuit board.

Although the invention has been described in its preferred form with a certain degree of particularity, it is understood that the present disclosure of the preferred form can be changed in the details of construction and in the combination and arrangement of parts without departing from the spirit and the scope of the invention as hereinafter claimed.

What is claimed is:

1. A dust remover comprising:
a dust removal roller for removing dust attached on a surface of a dust removal object by coming in contact with said surface of said dust removal object while rotating; and
an adhesive tape roller having an adhesive layer on its outer peripheral face and being disposed such that its outer peripheral face is brought into contact with an outer peripheral face of said dust removal roller to thereby transfer the dust adherent to the outer peripheral face of said dust removal roller to said adhesive layer of said adhesive tape roller to clean said dust removal roller while rotating with its outer peripheral face in contact with the outer peripheral face of said dust removal roller;
wherein an outer peripheral layer of said dust removal roller comprises a non-silicone elastic body, and a difference Δδ between a solubility parameter δ_{A} of said non-silicone elastic body and a solubility parameter δ_{B} of an adhesive forming said adhesive layer of said adhesive tape roller is 1.0 [J/cm³]^{½} or greater.

2. A dust remover according to claim 1, wherein said difference Δδ is in a range of 1.0 to 8.0 [J/cm³]^{½}.

3. A dust remover according to claim 1, wherein said difference Δδ is in a range of 2.0 to 6.0 [J/cm³]^{½}.

4. A dust remover according to claim 1, wherein said non-silicone elastic body is at least one member selected from the group of consisting of natural rubber, butyl rubber, acrylic rubber, nitryl rubber, thermoplastic elastomer, and polyurethane.

5. A dust remover according to claim 1, wherein said adhesive forming said adhesive layer is at least one member selected from the group of consisting acrylic adhesive, rubber-based adhesive, urethane-based adhesive, and olefin-based adhesive.
